(19) United States
(12) Patent Application Publication
(10) Pub. No.: US 2025/0172179 A1
(43) Pub. Date: May 29, 2025

(54) METHOD FOR CALIBRATING A CLUTCH CONTROL

(71) Applicant: ZF Friedrichshafen AG, Friedrichshafen (DE)

(72) Inventors: Stephan SCHINACHER, Egesheim (DE); Mario HASEL, Hergatz (DE)

(21) Appl. No.: 18/963,561

(22) Filed: Nov. 28, 2024

(30) Foreign Application Priority Data
Nov. 29, 2023 (DE) 10 2023 211 925.0

(51) Int. Cl. F16D 48/06; B60L 15/20

(52) U.S. Cl. CPC F16D 48/06; B60L 15/20; F16D 2500/10406; F16D 2500/1064; F16D 2500/30402; F16D 2500/30404; F16D 2500/3065; F16D 2500/3067

(57) ABSTRACT

A method for calibrating a clutch control of a drivetrain of a motor vehicle, wherein the drivetrain has a motor configured as an electric motor, the method including blocking an output of the drivetrain, operating the motor with a value for a first operating variable, and actuating a clutch with a first value for a clutch actuating variable. The method further includes ascertaining a first value of a second operating variable of the motor when the clutch is actuated with the first value and actuating the clutch with a second value for the clutch actuating variable. The method further includes ascertaining a second value of the second operating variable of the motor when the clutch is operated with the second value for the clutch actuating variable and determining clutch characteristics data as a function of the ascertained first and second values of the second operating variable.

### CROSS REFERENCE TO RELATED APPLICATIONS

This application claims benefit to German Patent Application No. DE 10 2023 211 925.0, filed on Nov. 29, 2023, which is hereby incorporated by reference herein.

### FIELD

The present invention relates to a method for calibrating a clutch control of a drivetrain of a motor vehicle.

### BACKGROUND

Calibration routines are used for optimizing the control of vehicle transmissions, which, for example, are intended to compensate for component and manufacturing tolerances. This is meant to compensate, for example, for the fact that different clutches of the same series can transmit completely different torques when actuated in the same way. Due to individual tolerances, the clutches with the same control can otherwise close with varying strength. However, the actual contact pressure on the clutch is usually not ascertained as its measurement is very complex. The sensors required for this are usually not even installed in motor vehicles. Instead, only a filling compensation pressure is determined for calibration purposes, for example. For this purpose, a clutch with different pressure levels is actuated and, based on an ascertained rotational speed, it is determined when the clutch begins to transmit a torque that is greater than a drag torque. However, the correlation thus determined between clutch actuation and transmittable torque is small. Moreover, this method only allows calibration with a single operating point, for example.

Alternatively, calibration can also be carried out on a test bench directly after the clutch and/or transmission has been manufactured. However, such calibration is already complex and expensive in itself. In addition, recalibration can then only be carried out at the factory, for example during vehicle maintenance. For example, it is not possible to respond to the ageing of a clutch oil with a new calibration by the vehicle itself.

### SUMMARY

In an embodiment, the present disclosure provides a method for calibrating a clutch control of a drivetrain of a motor vehicle, wherein the drivetrain has a motor configured as an electric motor, the method comprising blocking an output of the drivetrain, operating the motor with a value for a first operating variable, and actuating a clutch with a first value for a clutch actuating variable. The method further comprises ascertaining a first value of a second operating variable of the motor when the clutch is actuated with the first value and actuating the clutch with a second value for the clutch actuating variable. The method further comprises ascertaining a second value of the second operating variable of the motor when the clutch is operated with the second value for the clutch actuating variable and determining clutch characteristics data as a function of the ascertained first value of the second operating variable and the ascertained second value of the second operating variable.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a system by which a clutch control of a drivetrain of a motor vehicle can be calibrated;

FIG. 2 schematically illustrates a method for determining an operating point during the calibration of the clutch control; and

FIG. 3 illustrates in a diagram an actuation of a clutch for calibrating its control.

### DETAILED DESCRIPTION

A first aspect relates to a method for calibrating a clutch control of a drivetrain. The calibration can cause a change in control parameters of one or more clutches of the drivetrain. The drivetrain has at least one clutch. The clutch can be configured as a multi-disk clutch, for example. The clutch can be operated by means of an electrohydraulic pressure control valve, for example. By energizing the pressure control valve, a proportional actuation pressure of the clutch can be set. However, depending on factors such as manufacturing tolerances, a proportional relationship between the applied current and the actuation pressure can vary for similar clutches. The drivetrain can be configured to generate and transmit a driving force for a motor vehicle. The drivetrain has a motor configured as an electric motor. The electric motor can, for example, be configured as a synchronous machine or asynchronous machine. The motor can, for example, be a traction motor of the motor vehicle. The motor vehicle can, for example, be configured as a passenger car, construction machine or agricultural machine.

The method involves blocking an output of the drivetrain. The output can be, for example, a driven axle or an output shaft of a transmission of the drivetrain. Blocking can be carried out, for example, by means of a parking brake or a service brake. If multiple clutches are present, it is additionally provided to fully close all clutches that are not to be calibrated in the power flow from the motor to the output. These clutches can, for example, be pressurized to their maximum capacity, thus providing an almost rotationally fixed connection.

The method involves operating the motor with a value for a first operating variable. The value can be a predefined value, for example. The operating variable can be, for example, a power, a rotational speed or a torque of the motor. In the case of an electric motor, respective operating variables can be ascertained and predetermined with high quality. For example, the torque of an electric motor can be set with high precision and maintained even under varying loads. The torque of the electric motor can, for example, be available as a measured variable in an inverter of the drivetrain. This means that no additional sensors are required. The operating variable can be transmitted, for example, in a data bus of the vehicle, such as a CAN bus, to an ECU, such as a transmission ECU. For the implementation of the calibration procedure, a structural adaptation of the drivetrain and additional elements, which are not required in regular clutch operation or driving mode, can thus be unnecessary.

The method involves an actuation of the clutch with a first value for a clutch actuating variable. The actuation of the clutch can, for example, occur while the motor is being operated at the value for the operating variable. The clutch actuating variable can be a control variable used to actuate the clutch. For example, the clutch actuating variable can be a voltage or a current flow with which the pressure control valve of the clutch is energized. By actuating, the clutch is operated with a pressure corresponding to the first value. Accordingly, the clutch is then partially closed, for example. The clutch can then, for example, transmit a torque corresponding to the first value for the clutch actuating variable.

The method comprises ascertaining a first value of a second operating variable of the motor when the clutch is actuated with the first value. The second operating variable can be a variable corresponding to a power of the motor, which differs from the first operating variable. This allows a state of the clutch to be inferred during actuation with the first value of the clutch actuating variable. The state can be a transmittable torque, for example, which corresponds to the first value of the clutch actuating variable. The ascertaining can be carried out using the drivetrain, for example. For example, a torque can be ascertained by means of the motor and alternatively or additionally the inverter, which is required to maintain the predetermined rotational speed. This torque corresponds to the transmittable torque of the clutch due to the blocked output of the drivetrain, optionally minus any drag torques in the drivetrain. Alternatively, for example, a rotational speed can be ascertained, which is established by the motor at a predetermined torque. Overall, an actuation degree of the clutch can be specified in this way.

The method involves actuating the clutch with a second value for the clutch actuating variable. The second value of the clutch actuating variable differs from the first value. For example, the second value of the clutch actuating variable can be greater than the first value. The method comprises ascertaining a second value of the second operating variable of the motor when the clutch is actuated with the second value. In this way, a second operating point of the clutch can be specified. Also when the clutch is actuated with the second value of the clutch actuating variable and the second value of the second operating variable of the motor is ascertained, the output of the drivetrain can be blocked and the motor can be operated with the value for its first operating variable.

Optionally, other operating points can also be considered for calibration. For example, the clutch can be actuated with a third value and optionally further values for the clutch actuating variable. Correspondingly, a third value and optionally further values for the second operating variable of the motor can then be ascertained when the clutch is actuated.

Optionally, the method can be repeated for different values for the first operating variable. For example, transmittable torques can be specified at a first level of motor speed and at a different second level of motor speed. This allows additional operating points to be determined and further data to be generated and considered for calibration. In addition, different clutch control parameters or clutch control characteristic curves can be calibrated for different rotational speeds.

The method involves a determining of clutch characteristics data as a function of the ascertained first value and the ascertained second value of the second operating variable. These clutch characteristics data can be used to calibrate the clutch control. For example, a relationship between the clutch actuating variable and the transmissible torque of the clutch can be determined by interpolation and, if more than two operating points are specified, by a compensation curve. This correlation can be stored and used for clutch control, for example by a transmission control. The clutch characteristics data can accordingly have a characteristic curve. For example, a clutch control characteristic curve can be changed depending on the determined clutch characteristics data. For the determining of clutch characteristics data, further parameters can optionally be considered, such as the value for the first operating variable of the motor, the first value for the clutch actuating variable and the second value for the clutch actuating variable.

In an embodiment of the method, it can be provided that the first operating variable is a speed of the motor, and the second operating variable is a torque of the motor. Thus the motor can be speed-controlled at least during calibration. For example, a transmittable torque through the clutch can be determined based on a current flow necessary to maintain the motor speed. The calibration can thus be particularly simple and accurate.

In an embodiment of the method, it can be provided that the first operating variable is a torque of the motor and the second operating variable is a speed of the motor. The motor can therefore be torque-controlled at least during calibration. In this way, an overloading of the clutch can be reliably avoided during calibration.

In an embodiment of the method, it can be provided that, when the clutch is actuated, respective values for the clutch actuating variable are controlled to achieve respective predetermined target values for the second operating variable. For example, instead of measuring the torque required to maintain a predetermined rotational speed at a predetermined value for the clutch actuating variable, the clutch actuating variable is controlled to achieve a predetermined torque for the motor at a predetermined rotational speed. Such a calibration method can result in a particularly low load on the motor. For example, this control can be used only for one value, such as the first value or the second value of the clutch actuating variable. However, this control can also be used for several or all values of the clutch actuating variable.

In an embodiment of the method, it can be provided that a quick filling of the clutch takes place before the clutch is actuated with one of the respective values for the clutch actuating variable. A quick filling can be a filling of a hydraulic actuator of the clutch before an actual actuation. This allows the actuator to be vented. During quick filling, the pressure control valve can be opened particularly wide, for example. Quick filling can allow for particularly fast calibration. Additionally, standardized actuation procedures, which are also used in normal operation, can be used for actuating the clutch during calibration. A time duration for quick filling can, for example, be firmly predetermined or determined as part of the calibration process. Quick filling can occur before each actuation of the clutch during the calibration process or only during some of the actuations. After the quick filling, a piston of the clutch can, for example, not yet be in contact with the clutch disks, and alternatively or additionally, a fan clearance can not yet be eliminated.

In an embodiment of the method, it can be provided that before actuating the clutch with one of the respective values for the clutch actuating variable, a filling compensation of the clutch takes place. This allows, for example, any residual oil in the actuator of the clutch to be taken into account. The filling compensation can be a filling of a hydraulic actuator of the clutch before an actual actuation and after the quick filling. A time duration can also be predetermined for the filling compensation. During the filling compensation, the pressure control valve can be opened less widely than during quick filling, for example, to avoid unintentional actuation and the onset of friction in the clutch. After filling compensation, a clutch piston can be in contact at minimum clutch torque. Blocking of the output can occur, for example, only after the first filling compensation.

In an embodiment of the method, it can be provided that the clutch is actuated a first time with the first value for the clutch actuating variable based on a less strongly actuated clutch and a second time with the first value for the clutch actuating variable based on a more strongly actuated clutch. Thereby the first value can be smaller than the second value and the clutch is therefore actuated less strongly. For example, the clutch can be actuated the first time after a filling compensation with the first value and the second time after actuating the clutch with the second value of the clutch actuating variable. This allows hysteresis to be ascertained during calibration, whereby only three instead of four operating point measurements can be necessary. Depending on whether the clutch is adjusted towards its open or closed position, the relationship between the actuating variable and the torque that can be transmitted to the clutch can differ. Accordingly, the correlation can be determined for both adjustment directions with little effort. Two corresponding characteristics curves can then be determined, or for example, a single characteristics curve with a hysteresis loop.

In an embodiment of the method, it can be provided that the method comprises a step of ascertaining a further value of the second operating variable of the motor when the clutch is not actuated. In this way, for example, a drag torque can be specified. The drag torque can be caused by friction in the drivetrain and, alternatively or additionally, a minimum torque transmission when the clutch is fully open. The drag torque does not correspond to any transmittable torque at the clutch, for example, and can be subtracted for clutch control purposes, for example. The determining of clutch characteristics data can be performed depending on the ascertained additional value of the second operating variable. For example, the additional value can be subtracted from the other ascertained values of the second operating variable to specify the torque that can be transmitted by the clutch. Respective characteristics curves for the clutch control can thus be offset or corrected by the drag torque.

In an embodiment of the method, it can be provided that the method comprises a step of changing a clutch control system depending on the determined clutch characteristics data. For example, respective control parameters and alternatively or additionally control characteristic curves of the clutch control can be changed. For example, the clutch control can be calibrated once during the initial operation of the vehicle. However, an adaptation of the clutch control can also occur over the vehicle's lifetime. For example, the calibration procedure can be carried out periodically. Calibration can take place, for example, after a predetermined mileage, after a predetermined time or every time the vehicle is started.

In an embodiment of the method, it can be provided that the clutch is monitored using the calibration method. For this purpose, the determined clutch characteristics data can be compared with previously determined clutch characteristics data or target clutch characteristics data. If deviations exceed a threshold value, an output can be generated, for example as an error message. This can signal to the user, for example, the necessity of clutch maintenance. For example, clutch wear can also be specified based on the determined clutch characteristics data or a change in determined clutch characteristics data.

In an embodiment of the method, it can be provided that the clutch characteristics data exhibit a relationship between the clutch actuating variable and a torque that can be transmitted by the clutch. This allows the clutch to be controlled according to the desired transmittable torques.

In an embodiment of the method, it can be provided that the clutch characteristics data have a coefficient of friction. For example, the calibration method can be used to specify the current friction coefficient of the clutch. This allows changes in the clutch oil and clutch friction linings to be considered.

In an embodiment of the method, it can be provided that the clutch characteristics data have a clutch hysteresis. This allows the clutch control to be calibrated to match the adjustment direction of the clutch.

In an embodiment of the method, it can be provided that the clutch characteristics data include a clutch wear indicator value. The clutch wear indicator value can, for example, be proportional to the transmittable torque and can be calculated as a percentage deviation from a target value. The clutch wear indicator value can be specified, for example, based on an average deviation in all determined operating points during calibration or based on a highest deviation in all determined operating points.

In an embodiment of the method, it can be provided that the method further comprises a step of ascertaining a clutch temperature, and the determining of clutch characteristics data is carried out depending on the ascertained clutch temperature. This allows the calibration to take into account that the clutch temperature has a significant influence on the friction in the clutch and thus on the transmittable torque. In addition, the calibration and also the clutch control can thus be carried out in a temperature-dependent manner. The clutch temperature can be, for example, a friction lining temperature or an oil temperature in the clutch.

A second aspect relates to a transmission control unit which is configured to carry out the method according to the first aspect. Respective further features, embodiments and advantages can be found in the descriptions of the first aspect. Conversely, features, embodiments and advantages of the second aspect also represent features, embodiments and advantages of the first aspect. The transmission control unit can be configured to actuate respective clutches of a motor vehicle. The transmission control unit can be configured to transmit respective control signals to a clutch actuator, to a motor control unit of the motor vehicle, and to a braking system of the motor vehicle. The transmission control unit can thus, for example, block the output of the motor vehicle's drivetrain, predetermine a value for the first operating variable of the motor and predetermine a value for the clutch actuating variable for actuating the clutch. Additionally, the transmission control unit can be configured to receive status signals from the motor control unit. For example, currently ascertained values of the second operating variable of the motor can be transmitted to the transmission control unit in this way. Furthermore, the transmission control unit can be configured to determine clutch characteristics data depending on the ascertained first value and the ascertained second value of the second operating variable.

A third aspect relates to a system which is configured to carry out the method according to the first aspect. Respective further features, embodiments and advantages can be found in the descriptions of the first aspect. Conversely, features, embodiments and advantages of the third aspect also represent features, embodiments and advantages of the first aspect.

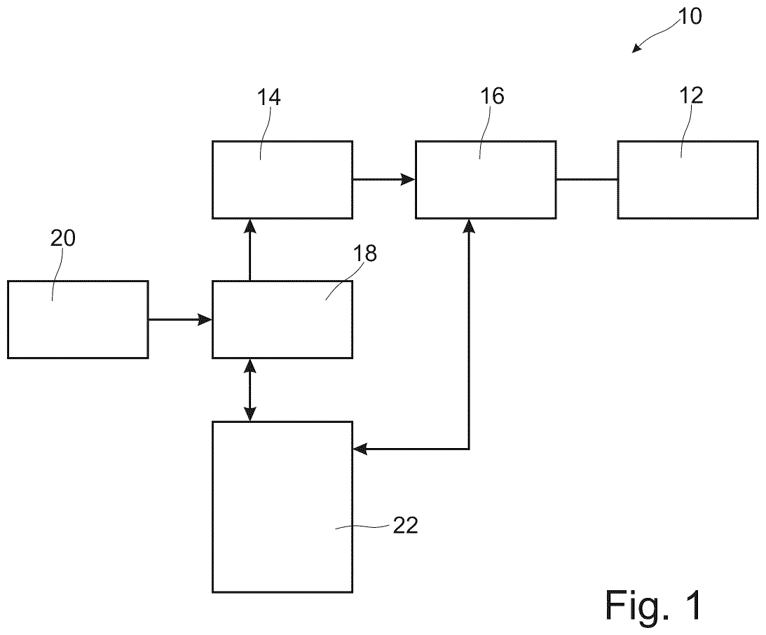

FIG. 1 shows a system 10 which is configured to calibrate a clutch control of a drivetrain of a motor vehicle. The system 10 has a brake 12, which is configured to block an output of the drivetrain. The system 10 comprises a motor 14 configured as an electric motor and a transmission 16, which is configured to transmit a driving force from the motor 14 to the output. In the example shown, the transmission 16 has only a single clutch, which in the example shown is configured as a multi-disk clutch. The system 10 includes an inverter 18, which controls a power supply of the motor 14 from an energy source 20. The inverter 18 is also configured to ascertain respective uncontrolled operating variables of the motor 14. Additionally, the system 10 includes a transmission control unit 22 configured as an ECU. The transmission control unit 22 is configured to control the clutch of the transmission 16 by setting a current flow for a pressure control valve. In addition, in an embodiment, the transmission control unit 22 is configured to ascertain a clutch temperature. In addition, the transmission control unit 22 can provide the inverter 18 with a target value for a motor speed and alternatively or additionally a motor torque. Furthermore, the transmission control unit 22 can receive a current value of the motor speed and, alternatively or additionally, of the motor torque from the inverter 18.

In the example shown, the motor 14 is speed-controlled. The inverter 18 thus provides the motor 14 with a value for a rotational speed as the first operating variable and regulates the power supply accordingly. From the required power supply, the inverter 18 derives a value for the motor torque as the second operating variable. If the motor 14 is operated at a fixed rotational speed, which is predetermined by the transmission control unit 22 during calibration, and the brake 12 blocks the output, the ascertained motor torque thus corresponds to a torque that can be transmitted through the clutch in the transmission 16.

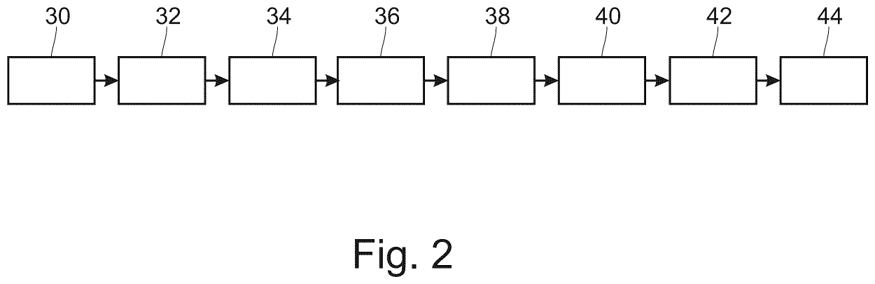

FIG. 2 illustrates a method for determining an operating point during a calibration of a clutch control of the clutch of the transmission 16. In a step 30, the calibration is activated. In a step 32, the output is blocked by means of the brake 12. In a step 34, a calibration of a quick filling and a filling compensation is performed. The quick filling and the filling compensation can bring a piston of the clutch into contact with disks while the clutch is still fully open. In a step 36, a fixed target rotational speed for the motor 14 is predetermined via the transmission control unit 22. In response, the inverter 18 controls a power supply so that the motor 14 maintains this target rotational speed. In a step 38, the motor torque generated in this process is ascertained via the inverter 18 and transmitted to the transmission control unit 22. This determined motor torque corresponds to a drag torque when the clutch is open. In a step 40, the clutch is controlled by the transmission control unit 22 with a value for a clutch actuating variable to actuate the clutch accordingly. The torque generated by the motor 14 when the clutch is actuated with the value of the clutch actuating variable is also ascertained. This results in a corresponding operating point at which the torque that can be transmitted by the clutch corresponding to a value of the clutch actuating variable was ascertained. Step 40 can be repeated several times to determine corresponding data for further operating points. The respective data collected in this way are used in step 42 to determine clutch characteristics data. In a simple embodiment, the data from two operating points are used to generate a straight line as a clutch control characteristics value. The specified clutch characteristics data or the clutch control calibrated therewith are stored by the transmission control unit 22 in a step 44.

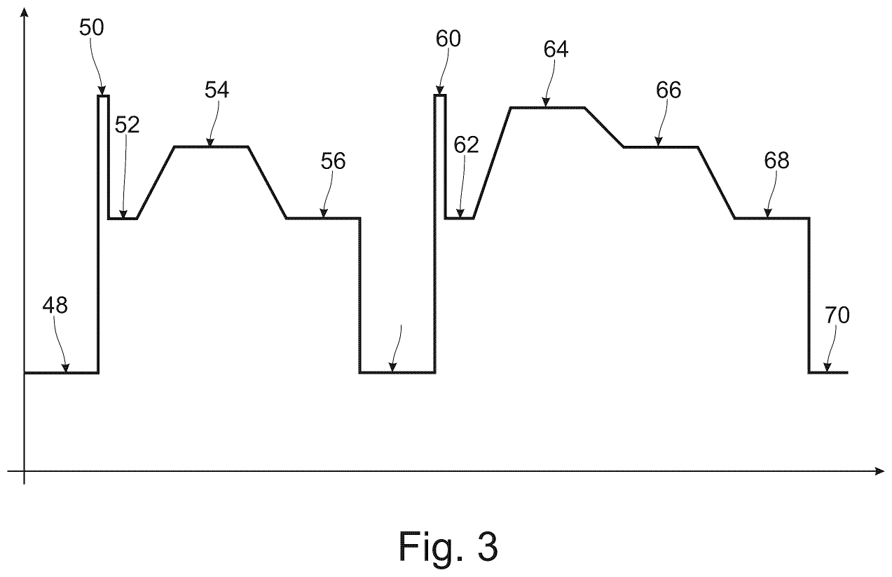

FIG. 3 illustrates in a diagram an embodiment for actuating the clutch or energizing the pressure control valve to actuate the clutch for the calibration of the clutch control. The current flow in mA is applied on the ordinate. An elapsed time in seconds is applied on the abscissa.

During calibration, the motor 14 is operated with a predetermined value for the motor speed as the first operating variable. In the area 48, the clutch is open and the output is blocked by the brake 12. The drag torque is determined. A first quick filling takes place in an area 50 and a filling compensation takes place in an area 52. Subsequently, the clutch is actuated in an area 54 with a first value for the clutch actuating variable, i.e. which corresponds to a specific level of current flow through the pressure control valve. The torque required to maintain the predetermined value for the motor speed is ascertained as the first value for the second operating variable of the motor 14. The clutch is then energized again in an area 56 with the value of the clutch actuating variable for the filling compensation and thus the clutch is opened again. A piston of the clutch remains in contact with the disks. In an embodiment, the torque required to maintain the predetermined value for the motor speed is ascertained as a value for the second operating variable of the motor 14 to determine a point of hysteresis in the clutch control.

Subsequently, a complete emptying of an actuator of the clutch occurs in an area 58, followed by a waiting period. After that a quick filling takes place again in an area 60, and in an area 62, a filling compensation occurs. Subsequently, the clutch is actuated in an area 64 with a second value for the clutch actuating variable, which is greater than the first value of the clutch actuating variable. The torque required to maintain the predetermined value for the motor speed is ascertained as the second value for the second operating variable of the motor 14. Subsequently, in an area 66, the clutch is actuated again with the first value of the clutch actuating variable and the clutch is thus slightly opened again. The torque required to maintain the predetermined value for the motor speed is ascertained in an embodiment as a further value for the second operating variable of the motor 14 to determine a further point of a hysteresis of the clutch control. The clutch is then energized again in an area 68 with the value of the clutch actuating variable for the filling compensation, and the clutch is thus fully opened again. One piston of the clutch remains in contact with the disks. In an embodiment, the torque required to maintain the predetermined value for the motor speed is ascertained as a value for the second operating variable of the motor 14 to determine further point of hysteresis of the clutch control.

Subsequently, an actuator of the clutch is completely emptied in an area 70. The measurements for the calibration are then completed in an embodiment. In another embodiment, there is a waiting period and then further operating points are determined at a different rotational speed level. After this waiting period, the motor 14 is operated with another predetermined value for the motor speed as the first operating variable, and the previously described areas 50 to 68 are run through again. In an embodiment, this is repeated for multiple different rotational speed levels.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

10 system
12 brake
14 motor
16 transmission
18 inverter
20 energy source
22 transmission control unit
30 step activating calibration
32 step blocking output
34 step calibrating quick filling and filling compensation
36 step predetermining a fixed target rotational speed
38 step transmitting motor torque to transmission control unit
40 step controlling clutch with value
42 step determining clutch characteristics data
44 step saving clutch characteristics data
48 area clutch open, output blocked
50 area first quick filling
52 area filling compensation
54 area actuating clutch with first value
56 area opening clutch
58 area complete emptying of actuator incl. waiting period
60 area quick re-filling
62 area filling compensation
64 area actuating clutch with second value
66 area actuating clutch with first value
68 area complete clutch opening
70 area complete actuator emptying

1. A method for calibrating a clutch control of a drivetrain of a motor vehicle, wherein the drivetrain has a motor configured as an electric motor, the method comprising:
blocking an output of the drivetrain:
operating the motor with a value for a first operating variable:
actuating a clutch with a first value for a clutch actuating variable:
ascertaining a first value of a second operating variable of the motor when the clutch is actuated with the first value:
actuating the clutch with a second value for the clutch actuating variable:
ascertaining a second value of the second operating variable of the motor when the clutch is operated with the second value for the clutch actuating variable; and
determining clutch characteristics data as a function of the ascertained first value of the second operating variable and the ascertained second value of the second operating variable.

2. The method according to claim 1, wherein the first operating variable is a rotational speed of the motor and the second operating variable is a torque of the motor.

3. The method according to claim 1, wherein the first operating variable is a torque of the motor and the second operating variable is a rotational speed of the motor.

4. The method according to claim 1, further comprising controlling, when the clutch is actuated, respective values for the clutch actuating variable to achieve respective predetermined target values for the second operating variable.

5. The method according to claim 4, further comprising carrying out a quick filling of the clutch before the clutch is actuated with one of the respective values for the clutch actuating variable.

6. The method according to claim 4, further comprising carrying out a filling compensation of the clutch before the clutch is actuated with one of the respective values for the clutch actuating variable.

7. The method according to claim 1, wherein the clutch is actuated a first time with the first value for the clutch actuating variable starting from a less strongly actuated clutch and a second time with the first value for the clutch actuating variable starting from a more strongly actuated clutch relative to the less strongly actuated clutch.

8. The method according to claim 1, further comprising ascertaining a further value of the second operating variable of the motor when the clutch is not actuated; and
determining clutch characteristics data as a function of the ascertained further value of the second operating variable.

9. The method according to claim 1, further comprising changing the clutch control as a function of the determined clutch characteristics data.

10. The method according to claim 1, wherein the clutch is monitored using a calibration method.

11. The method according to claim 1, wherein the clutch characteristics data comprises at least one of the following data:
a correlation between the clutch actuating variable and a torque that can be transmitted by the clutch;
a coefficient of friction;
a clutch hysteresis; and
a clutch wear indicator value.

12. The method according to claim 1, further comprising ascertaining a clutch temperature, wherein the determining of the clutch characteristics data takes place as a function of the ascertained clutch temperature.
